(19) United States
(12) Patent Application Publication
(10) Pub. No.: US 2008/0126789 A1
(43) Pub. Date: May 29, 2008

(54) Method and Apparatus for Generating an Optimal Number of Spare Devices Within a RAID Storage System Having Multiple Storage Device Technology Classes

(76) Inventors: Carl E. Jones, Tucson, AZ (US); Matthew J. Kalos, Tucson, AZ (US); Robert A. Kubo, Tucson, AZ (US); Richard A. Ripberger, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/467,758

(22) Filed: Aug. 28, 2006

(51) Int. Cl. G06F 1/00

(52) U.S. Cl. 713/100

(57) ABSTRACT

A method for generating an optimal number of spare devices within a RAID storage system having multiple storage device technology classes is disclosed. Each hard drive within the RAID storage system is assigned to a respective spare coverage group according to its attributes. From each of the spare coverage groups, at least one hard drive having a predetermined characteristics is selected as a spare device. A determination is then made as to whether or not an assigned spare device in one of the spare coverage groups is eligible to act as a spare device for another one of the spare coverage groups. In response to a determination that the assigned spare device in one of the spare coverage groups is also eligible to act as a spare device for another one of the spare coverage groups, a hard drive previously selected as a spare device for the other spare coverage group is removed as spare device.

### RELATED PATENT APPLICATION

The present patent application is related to copending application U.S. Ser. No. 11/292,747 (IBM Docket No. TUC20050022US1), filed on Dec. 1, 2005, the pertinent portion of which is incorporated herein by reference.

### BACKGROUND OF THE INVENTION

1. Technical Field

The present invention relates to data storage systems in general, and in particular to Redundant Array of Independent Disk (RAID) storage systems. Still more particularly, the present invention relates to a method and apparatus for generating an optimal number of spare devices within a RAID storage system having multiple storage device technology classes.

2. Description of Related Art

A Redundant Array of Independent Disk (RAID) storage system includes at least one RAID group having a set of hard drives capable of providing fault tolerance via data redundancy. In order to enhance the availability and reliability of RAID storage systems, RAID technology allows additional hard drives to be set up as spare devices capable of replacing any failed hard drives within a RAID array in the event of hard drive failures. Within a RAID storage system having multiple RAID arrays, the ability for any given hard drive to act as a spare device for all the RAID arrays is known as global sparing.

Hard drives commonly available in the market today can generally be categorized into several technology classes such as laptop-class drives, desktop-class drives, server-class drives and nearline-class drives. Nearline-class drives are intermediate class drives that fall between server-class drives and desktop-class drives. Designed for a lower duty cycle than server-class drives, nearline-class drives typically have higher storage capacities, lower performance, and lower reliability than server-class drives. Like desktop-class drives, nearline-class drives are available with SATA and P-ATA interfaces. Nearline-class drives are also available with FC-AL interfaces used in some server-class drives. Nearline-class drives that have an FC-AL interface are sometimes known as FATA. Nearline-class drives may also be manufactured with any of the other interfaces used by server-class drives such as SAS and parallel SCSI.

The present disclosure describes a method for generating an optimal number of spare devices for a RAID storage system having an intermix of nearline-class drives and server class drives.

### SUMMARY OF THE INVENTION

In accordance with a preferred embodiment of the present invention, a Redundant Array of Independent Disk (RAID) storage system includes multiple hard drives from different technology classes. In response to a configuration change on the RAID storage system, each hard drive within a global sparing domain of the RAID storage system is assigned to a respective spare coverage group according to its attributes. From each of the spare coverage groups, at least one hard drive having a predetermined characteristics is selected as a spare device. A determination is then made as to whether or not an assigned spare device in one of the spare coverage groups is eligible to act as a spare device for another one of the spare coverage groups. In response to a determination that the assigned spare device in one of the spare coverage groups is also eligible to act as a spare device for another one of the spare coverage groups, a hard drive previously selected as a spare device for the other spare coverage group is removed as spare device for the other spare coverage group.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high-level logic flow diagram of a method for generating an optimal number of spare devices within a RAID storage system having multiple storage device technology classes, in accordance with a preferred embodiment of the present invention; and

FIG. 2 is a block diagram of a computing environment in which a preferred embodiment of the present invention can be implemented.

### DETAILED DESCRIPTION OF A PREFERRED EMBODIMENT

Nearline-class hard drives and server-class hard drives can be utilized to assemble a Redundant Array of Independent Disk (RAID) storage system having an intermix of storage device technologies within the same global sparing domain; however, such arrangement can be problematic due to the differences in reliability characteristics. For example, the difference in the mean time between failure (MTBF) and performance (resulting data transfer rates of a hard drive in different input/output workloads) between nearline-class hard drives and server-class hard drives may result in a performance degradation of a RAID array and/or an increase in exposure to data loss from subsequent hard drive failures. Thus, it is typically not preferable to have a nearline-class hard drive present in a RAID array having server-class hard drives. Assignment of global spares may need to factor in this preference to ensure that there are enough enterprise class global spares to avoid the above-mentioned situation under most circumstances. On the other hand, even though there is generally no problem in using a server-class hard drive to serve as a globe spare device for a RAID array having nearline-class hard drives, it may not be the most optimal spare device assignment because server-class hard drives tend to be more expensive and have smaller storage capacities than their nearline-class counterparts.

While the goal of all spare device assignment algorithms is to assign the most optimal number of spare devices for a specific RAID storage system, some of the spare device assignment algorithms may not provide the best result for a RAID storage system having an intermix of nearline-class hard drives and server-class hard drives. For example, with capacity-based spare device assignment algorithms, the largest capacity hard drives are typically chosen as spare devices because they can provide the best coverage for the remaining hard drives due to their eligibility to replace any smaller capacity hard drive. Thus, for a RAID storage system having nearline-class hard drives and server-class hard drives, a conventional capacity-based spare device assignment algorithm will typically assign one or more of the nearline-class hard drives to be global spare devices because they are usually the largest capacity hard drives within a global sparing domain. However, the performance and reliability characteristics of nearline-class hard drives make them undesirable to act as global spare devices, especially in an online transaction processing system.

The present invention optimizes the assignment of spare devices to provide a statistical minimum level of redundancy for each storage device technology class within a RAID storage system having multiple storage device technology classes by automatically assigning spare devices that provide the best characteristics for each storage device technology class. When there is a configuration change that requires either a new device type or an additional hard drive to be assigned to meet the minimum level of redundancy for a storage device technology class, the RAID storage system responds by automatically assigning the spare devices required of the corresponding storage device technology class. The RAID storage system then algorithmically minimizes the number of spare devices that are configured of each storage device technology class at any time to provide the statistical spare device coverage required. The RAID storage system also frees some of the previously assigned spare devices when they are no longer required to provide the required level of redundancy for that storage device technology class.

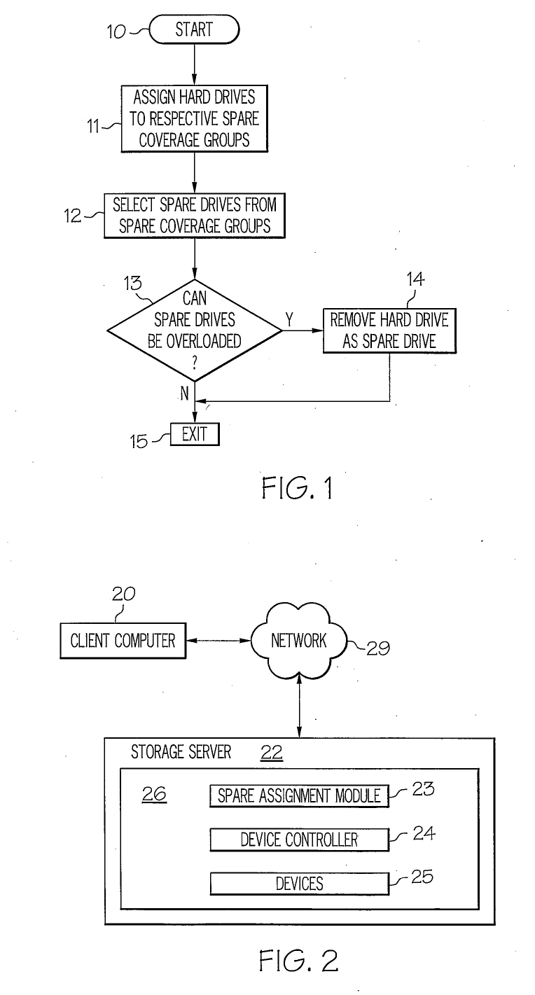

Referring now to the drawings, and specifically to FIG. 1, there is depicted a high-level logic flow diagram of a method for generating an optimal number of spare devices within a RAID storage system having multiple storage device technology classes, in accordance with a preferred embodiment of the present invention. Starting at block 10, in response to a configuration change on the RAID storage system, each hard drive within a global sparing domain of the RAID storage system is assigned under a respective spare coverage group according to its attributes, as shown in block 11. The attributes may include storage capacity, technology class and/or speed.

For example, four spare coverage groups can be formed for a RAID storage system designed to handle hard drives of two different storage capacities and two different technology classes, and each hard drive within a global sparing domain can be assigned to one of the four spare coverage groups based on its attributes. If there are 64 hard drives in the global sparing domain, then a first spare coverage group may contain sixteen 200 gigabyte nearline-class drives, a second spare coverage group may contain sixteen 100 gigabyte nearline-class drives, a third spare coverage group may contain sixteen 100 gigabyte server-class drives, and a fourth spare coverage group may contain sixteen 50 gigabyte server-class drives.

Then, for each spare coverage group, one or more hard drives are selected as spare devices based on certain predetermined characteristics, as depicted in block 12. The predetermined characteristics can be storage capacity, speed, or any attributes as desired.

To continued with the above-mentioned example, if two spare devices are desired from each of the four spare coverage groups, and all spare devices are required to have a minimum speed of 8,000 RPM, then two hard drives with a speed of 8,000 RPM or higher are selected from each of the four spare coverage groups as spare devices for their respective spare coverage group.

Next, a determination is made as to whether or not the selected spare device in one of the spare coverage groups is eligible to act as a spare device for another one of the spare coverage groups, as shown in block 13, in order to minimize the number of hard drives assigned as spare devices for the entire RAID storage system. If the selected spare device in one of the spare coverage groups is also eligible to act as a spare device for another one of the spare coverage groups, a hard drive previously selected as a spare device for the other spare coverage group is removed as spare device, as depicted in block 14. Otherwise, if the selected spare device in one of the spare coverage groups is not eligible to act as a spare device for another one of the spare coverage groups, the process exits in block 15 after all the selected spare devices have been evaluated.

In the above-mentioned example, initially, two 200 gigabyte nearline-class drives are selected as spare devices for the first spare coverage group, two 100 gigabyte nearline-class drives are selected as spare devices for the second spare coverage group, two 100 gigabyte server-class drives are selected as spare devices for the third spare coverage group, and two 50 gigabyte server-class drives are selected as spare devices for the fourth spare coverage group. With such selection, the two 100 gigabyte nearline-class drives can be removed as spare devices from the second spare coverage group because the two 100 gigabyte server-class drives from the third spare coverage group can act as spare devices for the second spare coverage group, providing the removal of two hard drives as spare devices still meet the minimum required number of spare devices for maintaining a robust RAID storage system.

With reference now to FIG. 2, there is depicted a block diagram of a computing environment in which a preferred embodiment of the present invention can be implemented. As shown, a client computer 20 is connected to a storage server 22 via a network 29. Storage server 22 provides client computer 20 with access to data in a device subsystem 26. A RAID storage system is implemented within storage server 22, and device subsystem 26 includes a RAID device controller 24 for controlling access to one or more RAID arrays formed by devices 25. Device subsystem 26 also includes a spare assignment module 23 for assigning one or more of devices 25 as spare devices via a spare device assignment algorithm.

As has been described, the present invention provides a method and apparatus for generating an optimal number of spare devices within a RAID storage system having multiple storage device technology classes.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for generating an optimal set of spare devices for a redundant array of independent disk (RAID) storage system, said method comprising:
in response to a configuration change on a RAID storage system having a plurality of hard drives with different technology classes, assigning each hard drive within a global sparing domain of said RAID storage system to a respective spare coverage group according to its attributes;
selecting, from each of said spare coverage groups, at least one hard drive having a predetermined characteristics as a spare device;
determining, for each of said spare coverage groups, whether or not a selected spare device is eligible to act as a spare device for another one of said spare coverage groups; and
in response to a determination that a selected spare device in one of said spare coverage groups is eligible to act as a spare device for another one of said spare coverage groups, removing a hard drive previously selected as a spare device for said another one of said spare coverage groups as spare device.

2. The method of claim 1, wherein RAID storage system includes nearline-class drives and server-class drives.

3. The method of claim 1, wherein said selected spare device in one of said spare coverage groups is a nearline-class drive.

4. The method of claim 1, wherein said attributes include storage capacity, technology class and/or speed.

5. The method of claim 1, wherein said predetermined characteristics include storage capacity and/or speed.

6. A computer usable medium having a computer program product for generating an optimal set of spare devices for a redundant array of independent disk (RAID) storage system, said computer usable medium comprising:
in response to a configuration change on a RAID storage system having a plurality of hard drives with different technology classes, computer code means for assigning each hard drive within a global sparing domain of said RAID storage system to a respective spare coverage group according to its attributes;
computer code means for selecting, from each of said spare coverage groups, at least one hard drive having a predetermined characteristics as a spare device;
computer code means for determining, for each of said spare coverage groups, whether or not a selected spare device is eligible to act as a spare device for another one of said spare coverage groups; and
in response to a determination that a selected spare device in one of said spare coverage groups is eligible to act as a spare device for another one of said spare coverage groups, computer code means for removing a hard drive previously selected as a spare device for said another one of said spare coverage groups as spare device.

7. The computer usable medium of claim 1, wherein RAID storage system includes nearline-class drives and server-class drives.

8. The computer usable medium of claim 1, wherein said selected spare device in one of said spare coverage groups is a nearline-class drive.

9. The computer usable medium of claim 1, wherein said attributes include storage capacity, technology class and/or speed.

10. The computer usable medium of claim 1, wherein said predetermined characteristics include storage capacity and/or speed.

11. A redundant array of independent disk (RAID) storage system capable of generating an optimal set of spare devices, said RAID storage system comprising:
a plurality of hard drives with different technology classes;
in response to a configuration change on said RAID storage system, means for assigning each hard drive within a global sparing domain of said RAID storage system to a respective spare coverage group according to its attributes;
means for selecting, from each of said spare coverage groups, at least one hard drive having a predetermined characteristics as a spare device;
means for determining, for each of said spare coverage groups, whether or not a selected spare device is eligible to act as a spare device for another one of said spare coverage groups; and
in response to a determination that a selected spare device in one of said spare coverage groups is eligible to act as a spare device for another one of said spare coverage groups, means for removing a hard drive previously selected as a spare device for said another one of said spare coverage groups as spare device.

12. The RAID storage system of claim 11, wherein RAID storage system includes nearline-class drives and server-class drives.

13. The RAID storage system of claim 11, wherein said selected spare device in one of said spare coverage groups is a nearline-class drive.

14. The RAID storage system of claim 11, wherein said attributes include storage capacity, technology class and/or speed.

15. The RAID storage system of claim 11, wherein said predetermined characteristics include storage capacity and/or speed.
